(19) United States
(12) Patent Application Publication
(10) Pub. No.: US 2025/0177989 A1
(43) Pub. Date: Jun. 5, 2025

(54) BIOCHEMICAL REACTION TEMPERATURE REGULATOR WITH STABILIZED, SELF-REGULATING HEAT SOURCE

(71) Applicant: DOMUS DIAGNOSTICS, INC., Park City, UT (US)

(72) Inventors: Joshua R. BUSER, Park City, UT (US); Daniel E. MORGAN, Salem, MA (US)

(21) Appl. No.: 18/970,704

(22) Filed: Dec. 5, 2024

Related U.S. Application Data
(60) Provisional application No. 63/606,214, filed on Dec. 5, 2023.

(51) Int. Cl. B01L 7/00

(52) U.S. Cl. CPC B01L 7/52; B01L 2300/0809; B01L 2300/1855; B01L 2300/1877

(57) ABSTRACT

The present disclosure is directed to a self-regulating temperature regulation system and related methods for regulating temperature during a biochemical reaction. The temperature regulation system includes: an expandable pouch comprising an inner cavity and a phase change material disposed within the inner cavity; a heat source comprising a pouch-facing side and an air-facing side, the pouch-facing side being in thermal contact with the pouch, the heat source being configured to generate heat upon activation and exposure to air and to cause phase change from liquid to gas of at least a portion of the phase change material; and a housing surrounding the heat source and pouch, the housing defining an air gap between the air-facing side of the heat source and an interior surface of the housing. The pouch is configured to expand as gas is generated within the inner cavity, thereby reducing the air gap and regulating air access to the heat source.

### CROSS-REFERENCE TO RELATED APPLICATIONS

This application claims priority to and the benefit of U.S. Provisional Patent Application No. 63/606,214, filed Dec. 5, 2023, the entirety of which is incorporated herein by reference.

### BACKGROUND

There is growing demand for diagnostic tools that can provide rapid and specific testing without requiring a patient to go to a hospital or wait weeks for a lab result. Laboratories have the advantage of state-of-the-art equipment that can perform a number of different biochemical reactions. Some of these reactions are temperature sensitive, and require a stable ambient temperature that is difficult to maintain without expensive equipment. In the absence of sufficient thermal homeostasis, the efficacy of such tests may be compromised. In certain instances, samples themselves may denature or become damaged when the temperature fluctuates. Further, depending on the process being performed, the reaction itself may be temperature dependent and may be less efficient, less effective, or less accurate if exposed to excessive temperature fluctuations and/or inadequate temperature ranges.

As one example, loop-mediated isothermal amplification (LAMP) assays can provide diagnostic tests which are a low-cost alternative to polymerase chain reaction (PCR) techniques. One specific variation of the LAMP technique is reverse transcription loop-mediated isothermal amplification (RT-LAMP). However, both LAMP and RT-LAMP reactions must typically be performed at a temperature of about 60 to about 70 degrees Celsius. When performed in the lab, temperatures can be monitored and relatively easily controlled. Outside the lab, however, such as with home or field testing, monitoring the temperature may be challenging or impossible. In these settings, temperature variations are common and can be detrimental to accurate and effective diagnostic testing.

As more techniques are developed for use outside of a conventional laboratory setting, temperature regulation has turned into a larger challenge. Accordingly, there is an ongoing need for effective tools for regulating temperature in chemical reactions, in particular biochemical reactions such as LAMP and RT-LAMP.

### SUMMARY

The present disclosure relates to a temperature regulation system, and related methods involving a self-regulating heat source. Embodiments described herein can solve one or more technical problems involving regulating temperature and maintaining temperature in a biochemical reaction.

For example, embodiments described herein can provide an insulated environment for a LAMP or RT-LAMP reaction, wherein a heat source can create and maintain a stable temperature for a biochemical reaction. In some embodiments, the reaction includes LAMP or RT-LAMP, such as carried out using a LAMP or RT-LAMP “card” or “chip” useful for remote (i.e., outside of the laboratory) assaying. In some embodiments, the heat source is an electronic heater or an exothermic reaction device.

In some embodiments, the temperature regulation system includes a sealed, expandable pouch comprising an inner cavity. The expandable pouch may be disposed between a heat source and biochemical reaction device (e.g., a microfluidic device) configured to carry out one or more biochemical reactions. A liquid/gas phase change material is disposed within the inner cavity. When a heat source is activated, the phase change material can begin to change from liquid to gas and cause the pouch to expand. That is, when the temperature reaches the boiling point of the phase change material, a liquid to gas phase transition occurs, leading to expansion of the pouch. While the phase change material undergoes phase change, the temperature within the sealed pouch will be maintained at or close to the boiling point and can therefore beneficially buffer any temperature fluctuations inherent in the heat source.

The temperature regulation system can include a housing that surrounds the other components of the temperature regulation system. The housing can include an interior surface facing the heat source and spaced from the heat source by an “air gap” (at least while the heat source is inactive and cooled). The expandable pouch can be disposed on the side of the heat source opposite the side facing the interior surface. The pouch expands when the heat source is activated, causing the pouch to move the heat source towards the interior surface of the housing, thereby constricting the air gap. As the air gap is constricted, less oxygen is available to the heat source. This beneficially provides a self-regulating function that limits the heat-generating reaction and leads to a more effective and longer lasting heating profile.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the disclosure will become apparent and more readily appreciated from the following description, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 illustrates an example of a temperature regulation system in an open configuration to show interior components of the system.

FIG. 2 illustrates an example of an activation mechanism used to activate a heat source in a temperature regulation system or device.

FIG. 3 illustrates the temperature regulation system in a closed configuration.

FIG. 4 illustrates an example of an insulating layer disposed to form an oxygen inlet.

FIGS. 5A and 5B are cross-sectional views of the temperature regulation system, with FIG. 5A showing the system in a pre-heated or early heating configuration and FIG. 5B showing the system in a heated form.

FIG. 6 illustrates performance advantages of one embodiment of the temperature regulation system over a conventional temperature regulation system.

### DETAILED DESCRIPTION

### Introduction

The embodiments described herein can solve one or more of the problems associated with temperature regulation of biochemical reactions discussed above. The embodiments described herein are particularly useful for low cost and/or remote applications where power and/or standard laboratory equipment is not readily available or is not economically feasible. Specifically, the embodiments described herein can enable a biochemical reaction within an environment that maintains a desired ambient temperature for an extended duration outside of a laboratory setting.

As explained in greater detail below, the temperature regulation device and temperature regulation systems that incorporate such a device, may be used to regulate temperature in a variety of different temperature sensitive biochemical reactions, such as a LAMP or RT-LAMP reaction. These reactions typically have a target temperature of between about 60° C. and about 70° C. and can take up to 40 minutes in a laboratory setting. The disclosed temperature regulation device, when used in a temperature regulation system, can be used to provide a stable temperature for a heat sensitive biochemical reaction such as LAMP or RT-LAMP for a sufficient duration.

The disclosed temperature regulation device may also be utilized in other isothermal amplification reactions, such as rolling circle amplification (RCA). RCA typically has a target temperature of about 30 to about 45 degrees Celsius, though in some instances it may be performed at even lower temperatures. Furthermore, RCA reactions can take about an hour to complete in a laboratory setting.

In a controlled laboratory setting, temperature is readily regulated. However, when performing LAMP or RT-LAMP based assays, or other biochemical reactions, in a home or field setting, regulating the temperature may be challenging. Sustaining a desired temperature for an appropriate amount of time can pose additional challenges. As used herein, a “remote” setting will refer to any environment in which finely controlled, laboratory-grade temperature regulation is not available and/or is not convenient. Examples include a home setting, a field setting, an outdoor setting, a setting where power supply is not readily available, a temporary “pop-up” clinic setting, a mobile medical unit, or even a healthcare facility where cost or operator training limitations reduce the feasibility of providing biochemical reactions with laboratory-grade temperature regulation.

As discussed above, certain biochemical reactions require a specified temperature range and a specified amount of time to be effectively carried out. With LAMP or RT-LAMP, for example, the temperature is preferably maintained at about 60 to about 70 degrees Celsius, with typical assays being carried out in about 30 to about 40 minutes. The temperature regulation device described herein can be used in conjunction with one or more biochemical reaction chambers, which may be associated with a microfluidic reaction device, such as one or more LAMP or RT-LAMP reaction devices, and a heat source, to create a temperature regulation system for effectively regulating temperature while the reaction is carried out.

### Example Temperature Regulation System

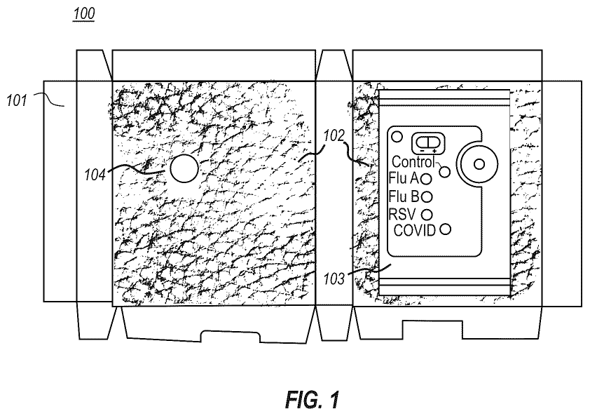

FIG. 1 illustrates an embodiment of a temperature regulation system 100 that is usable to carry out a biochemical reaction in a remote setting. The temperature regulation system 100 comprises a housing 101 that can include an insulation layer 102 that surrounds a biochemical reaction device 103 (e.g., a microfluidic device), also referred to herein as a reaction card 103, and a heat source (in this embodiment, below the microfluidic device 103 and not shown in this view) such that the housing 101 can shield and insulate a reaction taking place inside the microfluidic device 103 from the external environment. The temperature regulation system 100 can beneficially maintain a substantially constant temperature in the biochemical reaction device 103 and additionally or alternatively can shield the reaction device from environmental factors such as rain, wind, debris, or other factors that could interfere with a reaction.

The biochemical reaction device 103 in this example includes five reaction chambers in which various biochemical reactions can be carried out, such as reactions that enable LAMP, RT-LAMP and/or other isothermal reactions. Although biochemical reaction device 103 is exemplified herein, it will be understood that other devices that include one or more biochemical reaction chambers may also be utilized with the disclosed system to receive controlled heating.

The housing 101 can be formed from cardboard, plastic, metal, and/or any other material(s) suitable to surround the other components of the temperature regulation system. The housing 101 can be a foldable box, a container with a lid, a pouch, a bag, or any other container capable of surrounding the other components of the temperature regulation system 100, for example.

The insulation layer 102 of the housing 101 can comprise a metallic film, a polymer film, polystyrene foam, a fabric, and/or any other material capable of providing insulation to the temperature regulation system 100. The housing 101 can optionally comprise an aperture 104. The aperture 104 can optionally provide a vent and/or access port for the biochemical reaction device 103 and/or the temperature regulation system 100.

The biochemical reaction device 103 can carry out one or more biochemical reactions, chemical reactions, and/or any other processes that requires a substantially constant heat source without the use of laboratory equipment or an external source of power. The dimensions of the embodiment in FIG. 1 are representative of one use of the system and can be scaled up, down, or augmented to accommodate a desired reaction or set of reactions.

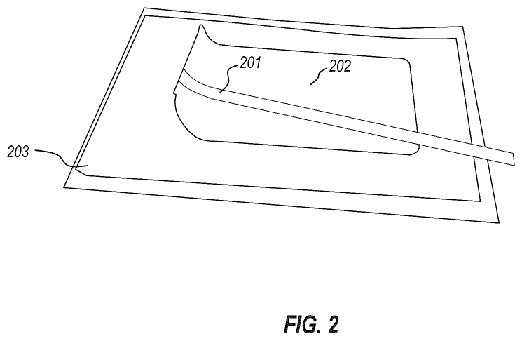

FIG. 2 illustrates an embodiment of a heat source 203 for use in the temperature regulation system 100. The heat source 203 can comprise an exothermic and/or endothermic reaction mechanism, though presently preferred embodiments are configured to carry out a heat-generating, exothermic reaction that utilizes ambient air (e.g., oxygen in the ambient air), such as are known in the art.

The heat source 203 can be activated by a pull tab 201 that removes a film 202, exposing the heat source 203 to the air, as shown. An operator can remove the film 202 from the heat source using the pull tab 201. Other mechanisms such as a mechanical slider connected to the film 202, a mechanism for puncturing a frangible seal, and/or other features capable of selectively exposing the contents of the heat source to air may additionally or alternatively be utilized.

The heat source 203 can be air activated or can be additionally or alternatively activated by another mechanism such as exposure to moisture or mechanical movement including shaking, twisting, cracking, and compression. The embodiment illustrated in FIGS. 2A and 2B is representative of one means of activating a heat source for use in the temperature regulation system 100 and can accommodate additional or separate means of activation that are compatible with the overall system.

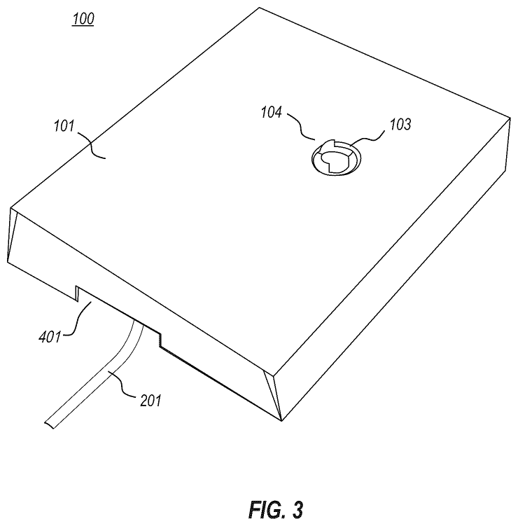

FIG. 3 illustrates the temperature regulation system 100 in a closed configuration, protecting the reaction from the environment and assisting in maintaining a stable temperature within the housing 101. The aperture 104 can optionally provide a vent and/or access port for accessing the biochemical reaction device 103 and/or other interior components of the temperature regulation system 100. The closed temperature regulation system 100 can optionally include an exposed activation mechanism such as the pull tab 201, which can be used to activate the heat source 203 disposed within the housing without the need to open the housing 101. The pull tab 201 (and/or other activation mechanism) can pass out through an oxygen inlet 401, described in more detail below.

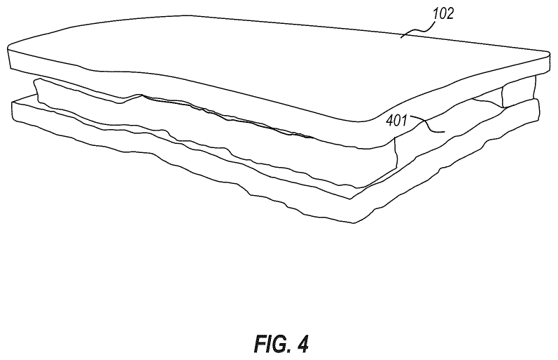

The housing 101 can be configured so that when the temperature regulation system 100 is in the closed configuration, the insulation layer 102 (see FIGS. 1 and 4) is positioned to promote thermal insulation of the biochemical reaction device 103. The insulation layer 102 can include an “upper” segment disposed above the biochemical reaction device 103 and a “lower” segment disposed below the biochemical reaction device 103. The “upper” and “lower” designations are used with respect to the illustrated orientation of the system 100 but should not be understood to necessitate the illustrated orientation. Other embodiments, for example, may utilize the system 100 in a more upright/vertical orientation. Other insulation segments may additionally or alternatively be utilized, such as one or more additional upper segments, additional lower segments, side segments, perimeter segments, and the like. In some embodiments, the housing 101 can itself be configured with insulative properties, reducing or eliminating the need for separate interior insulation.

FIG. 4 illustrates an embodiment of the insulation layer 102 used in the temperature regulation system 100 that is structured to allow air to flow through an oxygen inlet 401, providing a driver for the heat source held therein. The insulation layer 102 can include one or more oxygen inlets 401. In one embodiment, opposing oxygen inlets 401 are disposed on opposite sides of the insulation layer 102 to create a substantially linear channel extending into and through the insulation layer 102, while the remaining perimeter of the insulation layer 102 remains free of inlets. The number and size of oxygen inlets 401 can be configured according to an oxygen demand of the heat source housed within the insulation layer 102, as described in further detail below.

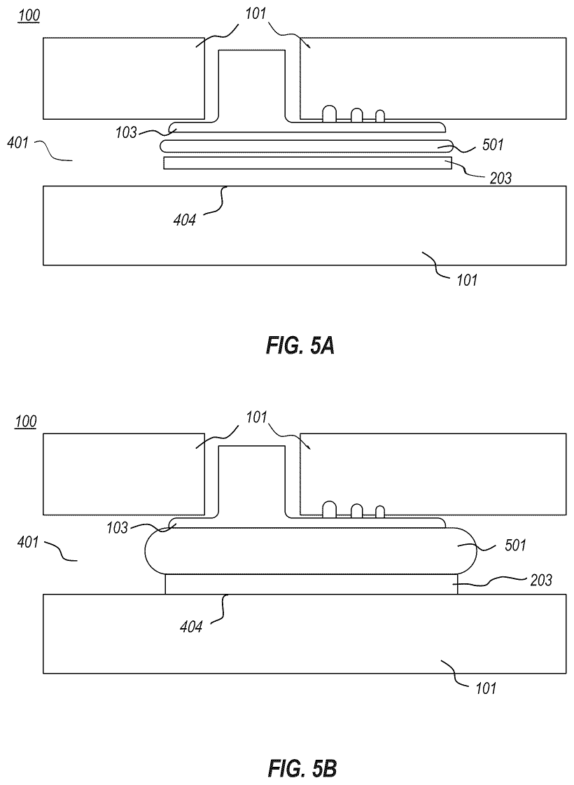

FIGS. 5A and 5B are cross-sectional views of the example temperature regulation system 100. As discussed above, the housing 101 can include an insulation layer 102, but the insulation layer 102 is omitted from this view for clarity.

As shown, the system 100 includes a sealed pouch 501 (e.g., formed from a film material) comprising an inner cavity. A phase change material and optionally a solid carrier are disposed inside of the inner cavity. A first side of the pouch 501 is in thermal contact with the heat source 203, and a second side of the pouch is in thermal contact with the biochemical reaction device 103.

The heat source 203 includes a pouch-facing side in thermal contact with the pouch 501 and an air-facing side opposite the pouch-facing side. The housing 101 is configured to support the biochemical reaction device 103, sealed pouch 501, and heat source 203 so that when the heat source 203 is inactive/cool, the air-facing side of the heat source 203 is spaced apart from an interior surface 404 defined by housing 101 (e.g., defined by an interior surface of the insulation layer 102 of housing 101). The spacing forms an “air gap” between the air-facing side of the heat source 203 and the interior surface 404 such that air passing through oxygen inlet(s) 401 can also access the air-facing side of the heat source 203 to drive the generation of heat from the heat source 203.

In the configuration of FIG. 5A, when the heat source 203 is inactive/cool, the sealed pouch 501 has a relatively small height along the “stack axis”, which is the direction along which the heat source 203, sealed pouch 501, and biochemical reaction device 103 are stacked. In the view of FIG. 5A, the stack axis corresponds to the vertical axis, though the stack axis need not always align with the vertical axis and the system 100 can be utilized in other orientations.

The heat source 203 can be activated (e.g., via pull tab 201 as shown in FIGS. 2 and 3) to supply heat to the pouch 501, causing the phase change material to undergo a phase change from liquid to gas, thereby causing the pouch 501 to expand along the stack axis. This expansion pushes the heat source 203 toward the interior surface 404, thereby closing the air gap between the air-facing side of the heat source 203 and the interior surface 404.

FIG. 5B shows the configuration of the system 100 when the pouch 501 has expanded sufficiently to push the heat source 203 into contact with the interior surface 404, thereby minimizing or blocking the air gap and restricting air from accessing the heat source. The expanded pouch 501 maintains a constant temperature against the biochemical reaction device 103 while the phase change material undergoes a phase change from liquid to gas, the temperature being approximately equal to the boiling point of the phase change material.

The configuration of the system 100 automatically regulates the heat source 203. When expanding pouch 501 causes the heat source 203 to move toward the interior surface 404, it reduces the amount of air passing to the air-facing side of the heat source 203, thereby restricting the ability of the heat source 203 to generate heat. This prevents the heat source 203 from expending too much heat-generating capacity in too short a time, and instead allows the heat source 203 to self-regulate and maintain heat-generating capacity for a more sustained duration.

The illustrated system 100 can allow the heat source 203 to heat up relatively quickly while the pouch 501 is in a pre-expanded form. When the pouch 501 starts to expand as heat is transferred to the pouch 501, the space between the air-facing side of the heat source 203 and the interior surface 404 becomes progressively more restricted, regulating the power output of the heat source 203, This beneficially conserves the heat-generating capacity of the heat source 203 and allows for a longer lasting target temperature inside the temperature regulation system 100.

If the heat source 203 is restricted to the point that more of the phase change material within the pouch 501 begins to condense, the pouch 501 will correspondingly begin to collapse and move toward a smaller height along the stack axis. This will move the heat source 203 away from the interior surface 404, increase the air gap, and allow more air to access the heat source 203, which in turn will allow the heat source 203 to generate more heat to prevent the phase change material from completely condensing and falling below the target boiling point temperature. In this manner, so long as the heat source 203 is still capable of generating heat upon exposure to air, the phase change material within the pouch 501 can be maintained at about the boiling temperature of the phase change material.

Beneficially, such temperature regulation is possible while extending the heat-generating capacity of the heat source 203. That is, regulating air access to the heat source 203 beneficially extends its capacity to carry out the heat-generating exothermic reaction, without reducing the ability of the heat source 203 to maintain the temperature of the pouch 103, which in turn maintains temperature of the biochemical reaction device 103.

The geometry of the pouch 501, the formulation and amount of the phase change material, and the size of the air gap between the heat source 203 and interior surface 404 can be configured together so that the phase change material maintains a temperature at about the boiling point of the phase change material throughout operation of the device (e.g., up until the heat source 203 is no longer able to generate heat). That is, the system 100 can be configured so that at full expansion of the pouch 501 (as shown in FIG. 5B), the phase change material has not yet completely boiled or has at least just reached full vapor phase. This reduces the risk of overheating of the phase change material to a temperature above the target boiling point temperature. Similarly, these components can be configured so that if restriction to the heat source 203 allows the phase change material to cool enough that more of it begins to condense, there is enough heat of condensation remaining in the phase change material to maintain temperature until the heat source 203 is re-exposed to air and begins to heat the pouch 501 again.

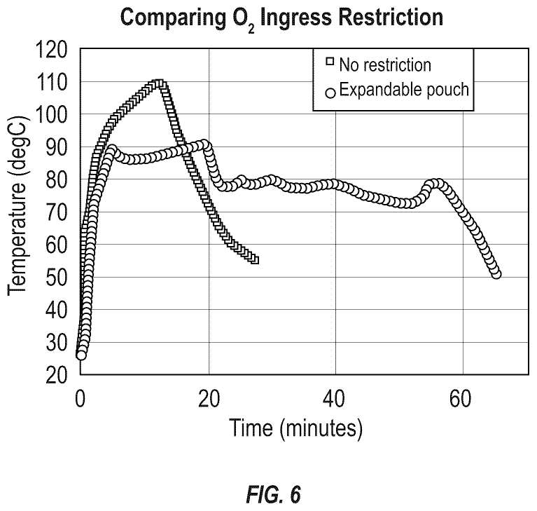

In some embodiments, such as those illustrated in 5A and 5B, the temperature regulation system 100 can maintain heat-generating capacity of the heat source 203 and can maintain a desired reaction temperature for over an hour, as illustrated by FIG. 6, which compares the temperature vs. time profile of a heat source with unrestricted access to air, and a heat source with a progressively restricted oxygen inlet such as shown in FIGS. 5A and 5B. Temperature was measured at the heat source itself-temperature at a corresponding pouch in thermal contact with the heat source would be expected to be more stable around the boiling temperature of the phase change material. As shown, the restricted heat source provides less variable and longer-lasting heat. In contrast, the unrestricted heat source climbs to a higher temperature that uses up the exothermic reaction and crashes relatively quickly thereafter. In some embodiments, the heat source 203 provides sufficient heat to initiate pouch expansion after about 10 minutes or less, such as about 5 minutes.

The amount of pouch expansion in FIG. 5B is illustrative, and other embodiments may involve different levels of pouch expansion when used. The amount and type of phase change material, the geometry of the pouch 501, and the material of the pouch 501 can be selected to control the amount of expected pouch expansion during use. For example, some embodiments involve a maximum pouch expansion of 0.5 mm to 25 mm, or 1 mm to 10 mm, or 2 mm to 5 mm, or an amount of expansion within a range with endpoints defined by any two of the foregoing values. The amount of expansion refers to the difference in the height of the pouch prior to heating and once fully expanded.

The amount of expansion can correspond to dimensions of the “air gap” between the air-facing side of the heat source 203 and the interior surface 404. For example, the pouch 501 and housing 101 can be configured so that the maximum amount of expansion is substantially equal to the height of the air gap so that the air gap becomes substantially fully restricted only upon maximum expansion of the pouch 501. In other words, the pouch can be configured such that a difference in height between a non-heated state (e.g., when the phase change material is at room temperature and/or the heat source 203 is inactive) and a fully expanded state is substantially equal to a height of the air gap.

In other embodiments, the pouch 501 and housing 101 can be configured so that a small air gap remains between the heat source 203 and the interior surface 404 even at maximum expansion of the pouch 501. For example, the air gap may gradually diminish as the pouch 501 expands, and therefore progressively lower the amount of oxygen available for the heat source 203, while still avoiding completely closing off the air gap.

### Pouch, Solid Carrier, and Phase Change Material

The pouch 501 may include a polyester-based film such as a polyethylene terephthalate (e.g., biaxially oriented polyethylene terephthalate (BoPET), known by the trade name MYLAR), polypropylene, nylon, polyethylene, and/or polypropylene, and may additionally or alternatively include other materials known in the art as suitable for film applications. For example, the film may be additionally or alternatively made of other polyester materials and/or other polymer materials appropriate as films for a temperature regulation device. The film may be metalized. A metalized film includes a thin coating of metal, typically aluminum, though other metals such as nickel and/or chromium may be utilized.

The optional solid carrier disposed inside the inner cavity of the pouch 501 can be formed of a suitable fabric, such as a poly broadcloth, a polyester/cotton blend fabric, and/or other fabric material capable of holding a solvent phase change material. In some embodiments, the solid carrier may additionally or alternatively include (e.g., non-fabric) solid materials such as, for example, absorbent beads, granular materials, sponge materials, paper or other cellulose material, fibrous materials, fiber bundles, or combinations thereof. The inclusion of a solid carrier can beneficially maintain effective distribution of the phase change material within the pouch 501.

Other embodiments may omit a solid carrier and simply include a phase change material directly added to the inner cavity of the pouch 501. The solid carrier, when included, can be sized to substantially match a planar surface area of the inner cavity of the pouch 501. For example, the solid carrier can be sized to equal at least 50%, at least 60%, at least 70%, at least 80%, at least 85%, at least 90%, or at least 95% (or a range using any two of the foregoing as endpoints) of the planar surface area of the inner cavity of the pouch 501. The edges of the pouch 501 can be sealed using a heat seal. In other embodiments, the pouch 501 may additionally or alternatively be sealed using adhesive, thread, staples, stitching, folding, and/or other methods appropriate for forming a pouch out of a film.

The solid carrier disposed inside the inner cavity of the pouch 501 can be soaked or dampened with the phase change material. The phase change material may include, for example, an inorganic solvent and/or an organic solvent. Suitable solvents include methanol, n-hexane, cyclohexane, ethanol, ethyl acetate, isopropanol, tert-butanol, benzene, tetrahydrofuran, other solvents, or combinations thereof. Generally, solvents are suitable where they exhibit relatively minimal toxicity and have boiling points at or slightly higher than the target temperature of the intended reaction. Solvent mixtures may also be utilized, particularly where the mixed solvents have similar boiling points. With solvent mixtures, one or more solvents of the mixture may exhibit a boiling point outside the target range of the intended reaction, but the overall temperature regulation effect of the mixture can still be effective for maintaining the reaction within the target temperature range.

The temperature regulation system 100 may be used to carry out a temperature sensitive chemical reaction such as an isothermal nucleic acid amplification reaction. Specifically, the isothermal nucleic acid amplification reaction could be a LAMP or RT-LAMP reaction. Such reactions require a stable temperature between about 60° C. and about 70° C. The temperature regulation system 100 can maintain an ambient temperature in this range for over an hour, illustrated by FIG. 6, which compares the temperature vs time profile of a heat source with unrestricted access to air, and a heat with a restricted oxygen inlet. The restricted heat source provides a more stable and long-lasting temperature to the temperature regulation system.

The solvent or solvent mixture can be tailored to arrive at a desired boiling point. In some embodiments, methanol can be used as the phase change material. Methanol has a boiling point of about 65 degrees Celsius. This results in methanol undergoing a liquid to gas phase change and therefore boiling at about 65 degrees Celsius. During the phase change, the temperature regulation device will thus regulate/maintain the temperature of the RT-LAMP reaction at about 65 degrees Celsius. In some embodiments, a mixture of ethanol and isopropanol can be used as the phase change material. Ethanol and isopropanol have higher boiling points (about 78 degrees Celsius and about 82 degrees Celsius, respectively), but can still be utilized in at least some applications for effective temperature regulation within the target LAMP/RT-LAMP range of 60 to 70 degrees Celsius.

The disclosed temperature regulation systems may also be utilized in other isothermal amplification reactions, that require temperature regulation at other ambient temperatures, such as rolling circle amplification (RCA). RCA typically has a target temperature of about 30 to about 45 degrees Celsius, though in some instances it may be performed at even lower temperatures. Furthermore, some biochemical reactions may have target temperatures of about 20 degrees Celsius, or 30 degrees Celsius, or 40 degrees Celsius, or 50 degrees Celsius, or 60 degrees Celsius, or 70 degrees Celsius, or 80 degrees Celsius, or 90 degrees Celsius, or even close to 100 degrees Celsius, or another value within a range defined by any two of the foregoing temperatures, and the phase change material can be selected accordingly.

The amount of phase change material added to the solid carrier may vary. For example, the temperature regulation device 100 can include about 0.01 mL, or 0.05 mL, or 0.1 mL, or 0.15 mL, or 0.2 mL, or 0.25 mL, or 0.5 mL, or 0.75 mL, or 1.0 mL, or 1.25 mL, or 1.5 mL, or 1.75 mL, or 2.0 mL, or 2.25 mL, or 2.5 mL of phase change material, or any value within a range defined by any two of the foregoing volumes.

The amount of phase change material may also vary according to the overall size of the temperature regulation system 100 and/or the size of the pouch 501. For example, the pouch 501 may have a planar surface area (e.g., from the surface that contacts the microfluidic device) of about 10 to about 100 square centimeters, or about 20 to about 80 square centimeters, or about 30 to about 60 square centimeters. Certain embodiments may be, for example, within about 0.5 to about 10 square centimeters or about 5 to about 25 square centimeters. The pouch 501 may be sized with a planar surface area within a range using any two of the foregoing values of this paragraph as endpoints. The foregoing phase change material volumes may apply to a similarly sized temperature regulation device and may be scaled accordingly for devices of other sizes. The amount of phase change material added, relative to the volume of the inner cavity of the pouch 501, can be adjusted to arrive at a desired level of pouch expansion, as discussed above.

Accordingly, the pouch 501 may include a phase change material volume to planar surface area ratio of about 0.05 μL/cm² to about 250 μL/cm², such as about 0.5 μL to about 225 μL, or about 1 μL to about 200 μL, or about 2.5 μL to about 175 μL, or about 5 μL/cm² to about 150 μL/cm², or about 25 μL/cm² to about 125 μL/cm², or about 50 μL/cm² to about 100 μL/cm², or a ratio within a range using any two of the foregoing values as endpoints.

During use, the temperature of the reaction will tend to be slightly lower than the temperature within the temperature regulation system 100 due to inherent heat transfer losses. Thus, in some implementations, the phase change material may be formulated with a boiling point that is slightly above the target temperature of the intended reaction. For example, the phase change material can be formulated with a boiling point that is 0.1, 0.5, 1, 2.5, 5, 7.5, 10, 12.5, or 15 degrees Celsius (or a range using any combination of the foregoing as endpoints) higher than a target reaction temperature. This intentional offset can account for such heat transfer effects and bring the reaction temperature closer to the intended target temperature.

Additional details regarding the pouch, phase change material, and solid carrier are disclosed in United States Patent Application Publication No. 2023/0392063, which is incorporated herein by reference.

### Additional Terms & Definitions

As used herein, the ability of the disclosed temperature regulation system to maintain a “stable temperature” of a biochemical reaction means the ability to maintain a temperature, as measured at the biochemical reaction, that fluctuates less than a system that does not regulate air access to the heat source but is otherwise configured the same as the disclosed system. For example, the “stable temperature” can stay vary from a target temperature by less than ±5° C., ±4° C., ±3° C., ±2° C., or ±1° C., over a measurement period of, for example, 20, 40, or 60 minutes.

As used herein, two components that are in “thermal contact” with one another means that heat can transfer from the higher temperature component to the lower temperature component with losses no greater than 20%, 15%, 10%, or 5%, for example. Thermal contact can involve direct contact between the two components, though direct contact is not strictly necessary.

As used herein, “heat-generating capacity” of the heat source refers to the ability of the heat source to generate levels of heat that are at least 65%, or at least 75%, or at least 85%, of the intended or maximum heat of the heat source.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

When the terms “about,” “approximately,” “substantially,” or the like are used in conjunction with a stated amount, value, or condition, it may be taken to mean an amount, value or condition that deviates by less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent may also include two or more such referents.

The embodiments disclosed herein should be understood as comprising/including disclosed components, and may therefore include additional components not specifically described. Optionally, components positively disclosed for an embodiment can be essentially or completely omitted from other embodiments. Optionally, an embodiment can be essentially free or completely free of components that are not specifically disclosed. That is, non-disclosed components may optionally be completely omitted or essentially omitted from the disclosed embodiments. For example, phase change materials, heat source types, and/or biochemical reaction device types that are not expressly disclosed herein may optionally be essentially omitted or completely omitted.

An embodiment that “essentially omits” or is “essentially free of” a component may include trace amounts and/or non-functional amounts of the component. For example, an “essentially omitted” component may be included in an amount no more than 1%, no more than 0.1%, or no more than 0.01% by total weight of the composition. This is likewise applicable to other negative modifier phrases such as, but not limited to, “essentially omits,” “essentially without,” similar phrases using “substantially” or other synonyms of “essentially,” and the like.

A composition that “completely omits” or is “completely free of” a component does not include a detectable amount of the component (i.e., does not include an amount above any inherent background signal associated with the testing instrument) when analyzed using standard coating composition analysis techniques such as, for example, chromatographic techniques (e.g., thin-layer chromatography (TLC), gas chromatography (GC), liquid chromatography (LC)), or spectroscopy techniques (e.g., Fourier transform infrared (FTIR) spectroscopy).

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A temperature regulation system for regulating temperature during a biochemical reaction, the system comprising:
an expandable pouch comprising an inner cavity, and a phase change material disposed within the inner cavity;
a heat source comprising a pouch-facing side and an air-facing side, the pouch-facing side being in thermal contact with the pouch, the heat source being configured to generate heat upon activation and exposure to air and to cause phase change from liquid to gas of at least a portion of the phase change material; and
a housing surrounding the heat source and pouch, the housing defining an air gap between the air-facing side of the heat source and an interior surface of the housing,
wherein the pouch is configured to expand as gas is generated within the inner cavity, the expansion reducing the air gap and modulating air access to the heat source.

2. The temperature regulation system of claim 1, further comprising a solid carrier disposed within the inner cavity.

3. The temperature regulation system of claim 1, wherein the pouch comprises polyester film, biaxially oriented polyethylene terephthalate (BoPET), or combination thereof.

4. The temperature regulation system of claim 1, wherein the phase change material comprises a solvent.

5. The temperature regulation system of claim 4, wherein the solvent comprises methanol, ethanol, isopropanol, or a combination thereof.

6. The temperature regulation system of claim 4, wherein the solvent has a boiling point between 20 degrees and 80 degrees Celsius.

7. The temperature regulation system of claim 1, wherein the pouch has a planar surface area of 10 to 100 square centimeters.

8. The temperature regulation system of claim 1, wherein the pouch comprises about 0.25 mL to 2.0 mL of phase change material.

9. The temperature regulation system of claim 1, wherein the pouch has a phase change material volume to planar surface area ratio of 2.5 μL/cm² to 250 μL/cm².

10. The temperature regulation system of claim 1, wherein the heat source is activatable by a pull tab.

11. The temperature regulation system of claim 1, wherein the heat source comprises an exothermic, oxygen-reactive device.

12. The temperature regulation system of claim 1, further comprising a biochemical reaction device in thermal contact with the pouch, the pouch comprising a first side in thermal contact with the heat source and a second side in thermal contact with the biochemical reaction device.

13. The temperature regulation system of claim 12, wherein the biochemical reaction device is configured to carry out an isothermal nucleic acid amplification reaction.

14. The temperature regulation system of claim 1, wherein the pouch is configured to expand in height along a stack axis defined by the direction along which the pouch and heat source are stacked.

15. The temperature regulation system of claim 1, wherein the housing comprises an insulation layer that includes one or more insulation segments for insulating the heat source and pouch.

16. The temperature regulation system of claim 1, wherein the pouch is configured such that a difference in height between a non-heated state and a fully expanded state is substantially equal to a height of the air gap.

17. A method for regulating temperature of a biochemical reaction, the method comprising:
providing a temperature regulation system as in claim 1;
activating the heat source to generate heat, wherein the phase change material undergoes a phase change and expands the pouch to thereby move the heat source toward the interior surface of the housing and reduces the size of the air gap.

18. The method of claim 17, wherein the pouch maintains stable temperature of a biochemical reaction device carrying out a biochemical reaction while in thermal contact with the pouch.

19. The method of claim 18, wherein the biochemical reaction comprises an isothermal nucleic acid amplification reaction.

20. The method of claim 17, wherein the heat source maintains heat-generating capacity for longer than the same heat source without regulated air access.
